(19) United States
(12) Patent Application Publication
(10) Pub. No.: US 2018/0291835 A1
(43) Pub. Date: Oct. 11, 2018

(54) CYLINDER HEAD COVER

(71) Applicant: Toyota Jidosha Kabushiki Kaisha, Toyota-shi (JP)

(72) Inventor: Takashi AMANO, Susono-shi (JP)

(73) Assignee: Toyota Jidosha Kabushiki Kaisha, Toyota-shi (JP)

(21) Appl. No.: 15/943,939

(22) Filed: Apr. 3, 2018

(30) Foreign Application Priority Data
Apr. 11, 2017 (JP) 2017-078349

(51) Int. Cl. F02F 7/00; F02B 77/13

(52) U.S. Cl. CPC F02F 7/008; F02B 77/13; F02F 7/006

(57) ABSTRACT

A cylinder head cover for an internal combustion engine includes a density changed portion provided to extend in a thickness direction of the cylinder head cover. The density changed portion divides the cylinder head cover into a plurality of parts. The density changed portion has a density different from a density of a portion of the cylinder head cover other than the density changed portion.

### INCORPORATION BY REFERENCE

The disclosure of Japanese Patent Application No. 2017-078349 filed on Apr. 11, 2017 including the specification, drawings and abstract is incorporated herein by reference in its entirety.

### BACKGROUND

### 1. Technical Field

The disclosure relates to a cylinder head cover.

### 2. Description of Related Art

An engine cover (a sound insulation cover) is disclosed in Japanese Patent Application Publication No. 2006-250054 (JP 2006-250054 A). The engine cover is provided at a position away from a surface of a cylinder head cover and covers an internal combustion engine from above to suppress vehicle exterior noise.

### SUMMARY

However, because the engine cover disclosed in JP 2006-250054 A does not suppress noise itself generated by the internal combustion engine, the engine cover may not sufficiently suppress the vehicle exterior noise.

The disclosure makes it possible to suppress noise itself generated by the internal combustion engine so as to suppress vehicle exterior noise.

A cylinder head cover for an internal combustion engine according to an aspect of the disclosure includes a density changed portion provided to extend in a thickness direction of the cylinder head cover. The density changed portion divides the cylinder head cover into a plurality of parts. The density changed portion has a density different from a density of a portion of the cylinder head cover other than the density changed portion.

According to the aspect of the disclosure, noise generated by the internal combustion engine can be suppressed, and thus, vehicle exterior noise can be suppressed.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic perspective view of a cylinder head cover according to an embodiment of the disclosure;

FIG. 2 is a perspective view of the cylinder head cover according to the embodiment of the disclosure illustrated in a simplified manner;

FIG. 3 is a schematic sectional view of the cylinder head cover according to the embodiment of the disclosure that is taken along line III-III in FIG. 1;

FIG. 4 is a schematic sectional view of the cylinder head cover according to the embodiment of the disclosure that is taken along line IV-IV in FIG. 1;

FIG. 5 is a graph showing eigenvalue analysis results regarding cylinder head covers shown in FIG. 6A to FIG. 6C;

FIG. 6A is a perspective view of a cylinder head cover in a simplified manner, in which three density changed portions are provided at equally-spaced intervals in an entire length direction of the cylinder head cover;

FIG. 6B is a perspective view of a cylinder head cover in a simplified manner, in which the one density changed portion is provided at a center in the entire length direction of the cylinder head cover;

FIG. 6C is a perspective view of a cylinder head cover in a simplified manner, in which the density changed portion is not provided; and

FIG. 7 is a view showing vibration patterns in each of vibration modes from mode 1 to mode 4.

### DETAILED DESCRIPTION OF EMBODIMENTS

A detailed description will hereinafter be provided on an embodiment of the disclosure with reference to the drawings. In the following description, the same components will be denoted by the same reference numerals.

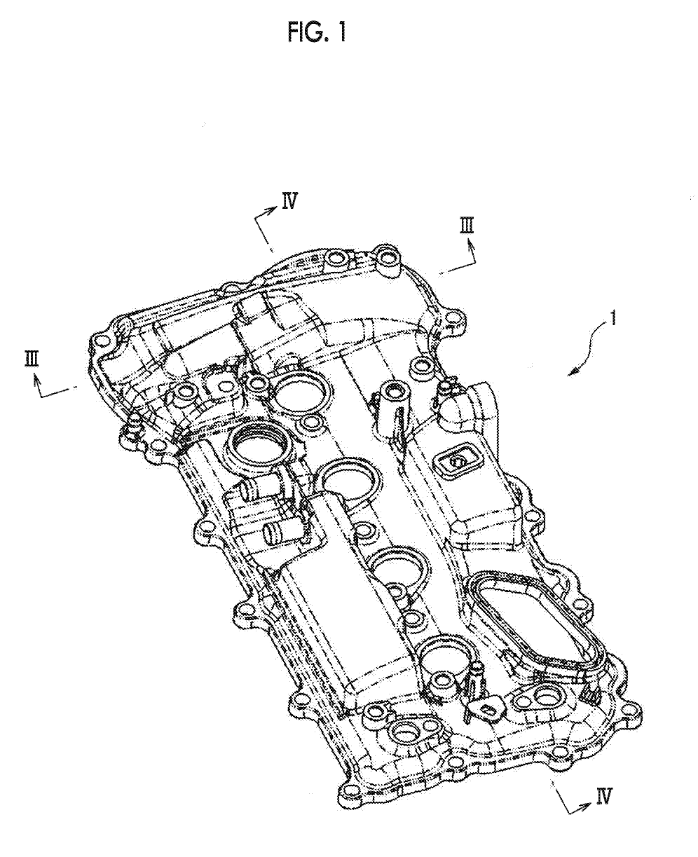

FIG. 1 is a schematic perspective view of a cylinder head cover 1 according to the embodiment of the disclosure.

The cylinder head cover 1 is attached to a cylinder head so as to close openings formed on a surface of a cylinder head (not shown) of an internal combustion engine. The cylinder head cover 1 prevents lubricant, which is used to lubricate a valve operating mechanism accommodated in the cylinder head, from scattering to the outside of the internal combustion engine from the openings in the cylinder head.

During an operation of the internal combustion engine, vibrations generated due to expansion resulting from combustion in a combustion chamber, reciprocal motion of a piston, and the like are transmitted to the cylinder head cover 1 to cause surface vibrations of the cylinder head cover 1. As a result, air that contacts the cylinder head cover 1 vibrates, and accordingly, noise is generated and is transmitted to the outside of a vehicle.

Thus, in order to suppress vehicle exterior noise, it is effective to reduce a magnitude (dB) of the noise resulting from the surface vibrations of the cylinder head cover 1.

In the case where a frequency of vibrations generated in a normal rotation speed range of the internal combustion engine (hereinafter referred to as an “engine vibration frequency”) matches a natural vibration frequency of the cylinder head cover 1, the cylinder head cover 1 exhibits resonance and increases the vehicle exterior noise.

Thus, in order to suppress the vehicle exterior noise, it is required to reduce the magnitude of the noise itself resulting from the surface vibrations of the cylinder head cover 1, and to set the natural vibration frequency of the cylinder head cover 1 so as to prevent the natural vibration frequency of the cylinder head cover 1 from matching the engine vibration frequency.

As methods of changing the natural vibration frequency of the cylinder head cover 1 for adjustment so as to prevent the natural vibration frequency of the cylinder head cover 1 from matching the engine vibration frequency, a method of providing a rib on a reverse surface of the cylinder head cover 1 for reinforcement, and a method of increasing the thickness of the cylinder head cover 1 are available, for example. However, in these methods, a weight of the cylinder head cover 1 is increased, and accordingly, a weight of the internal combustion engine is increased.

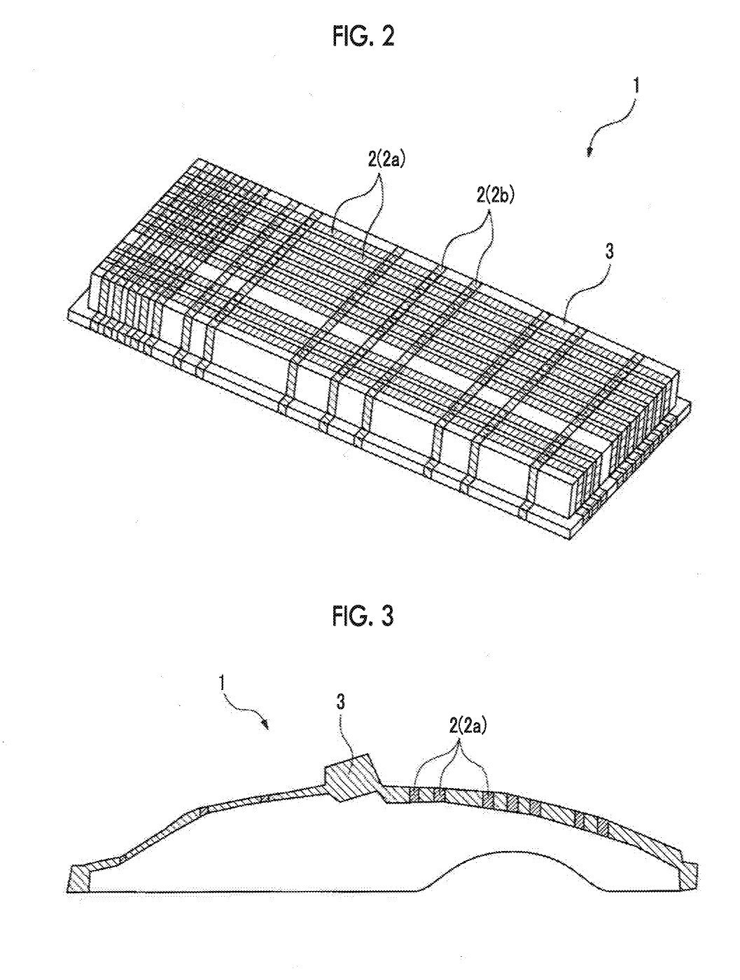

In view of the above, density of the cylinder head cover 1 is partially changed in the embodiment. In this way, the magnitude of the noise itself resulting from the surface vibrations of the cylinder head cover 1 can be reduced, and the natural vibration frequency of the cylinder head cover 1 can be set to any natural vibration frequency. A description will hereinafter be provided on an internal structure of the cylinder head cover 1 according to the embodiment with reference to FIG. 2 to FIG. 4.

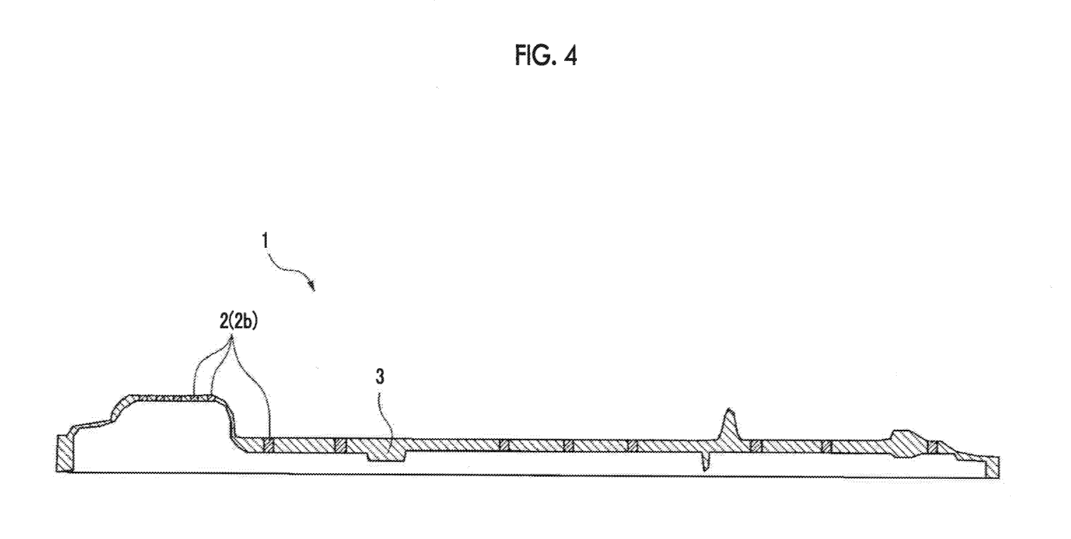

FIG. 2 is a simplified view of the cylinder head cover 1 according to the embodiment and is also a perspective view of the cylinder head cover 1 illustrating shaded portions where the density of the cylinder head cover 1 is partially changed (hereinafter referred to as “density changed portions 2”) in order to facilitate understanding. FIG. 3 is a schematic sectional view of the cylinder head cover 1 that is taken along line III-III in FIG. 1. FIG. 4 is a schematic sectional view of the cylinder head cover 1 that is taken along line IV-IV in FIG. 1. As a matter of convenience, a portion of the cylinder head cover 1 other than the density changed portions 2 in the cylinder head cover 1 will be referred to as a “main body portion 3” in the following description when necessary.

As shown in FIG. 2, the cylinder head cover 1 according to the embodiment includes a plurality of first density changed portions 2a and a plurality of second density changed portions 2b as the density changed portions 2. Each of the first density changed portions 2a has a linear shape, is formed to extend over an entire length of the cylinder head cover 1 in a longitudinal direction (hereinafter referred to as a “head cover longitudinal direction”), and has a specified width. Each of the second density changed portions 2b has a linear shape, is formed to extend over an entire length of the cylinder head cover 1 in a short direction (hereinafter referred to as a “head cover short direction”), and has a specified width. As shown in FIG. 3 and FIG. 4, each of the first density changed portions 2a and the second density changed portions 2b extends over an entire range of the cylinder head cover 1 in a thickness direction.

In the embodiment, each of the first density changed portions 2a and the second density changed portions 2b has the same density. The density of the first density changed portions 2a and the second density changed portions 2b is higher than that of the main body portion 3. A material of the first density changed portions 2a and the second density changed portions 2b is the same as a material of the main body portion 3. Only the density of the first density changed portions 2a and the second density changed portions 2b is different from the density of the main body portion 3. In the embodiment, the cylinder head cover 1 is integrally manufactured by using a three-dimensional (3D) printer. A fill density of the material for forming each density changed portion 2 is set to be higher than a fill density of the material for forming the main body portion 3. In this way, the density of the first density changed portions 2a and the second density changed portions 2b is set to be higher than the density of the main body portion 3. In the embodiment, an aluminum alloy is used as a material of the cylinder head cover 1, that is, the material of the main body portion 3 and the density changed portions 2. However, the material is not limited to the aluminum alloy. Another metal material may be used, or a resin material may be used.

Here, in order to reduce the magnitude of the noise itself resulting from the surface vibrations of the cylinder head cover 1, it is effective to reduce an area of a portion where the surface vibrations occur.

In the case of a cylinder head cover in which the density changed portion 2 is not provided, the entire main body portion 3 vibrates significantly when the vibrations are transmitted to the cylinder head cover. As a result, the air that contacts the cylinder head cover vibrates significantly, and accordingly, loud noise is generated.

In contrast, in the cylinder head cover 1 according to the embodiment, the first density changed portions 2a and the second density changed portions 2b are provided. Each of the first density changed portions 2a extends over the entire length of the cylinder head cover 1 in the head cover longitudinal direction, and each of the second density changed portions 2b extends over the entire length of the cylinder head cover 1 in the head cover short direction. In this way, the cylinder head cover 1 can be divided into a plurality of parts. In other words, because the main body portion 3 in which the surface vibrations occur is finely divided into parts by the density changed portions 2, an area of each of the parts of the main body portion 3, in which the surface vibrations occur, can be made small. Thus, a magnitude of the vibrations generated in each of the parts, into which the main body portion 3 is divided, can be made small, and the noise itself can be decreased.

Furthermore, as a result of the research conducted by the inventor, it was found that the natural vibration frequency of the cylinder head cover 1 can be easily changed for adjustment by changing the number, the width, the shape, or the density of the density changed portions 2 when the density changed portions 2 are provided in the cylinder head cover 1 as in the embodiment.

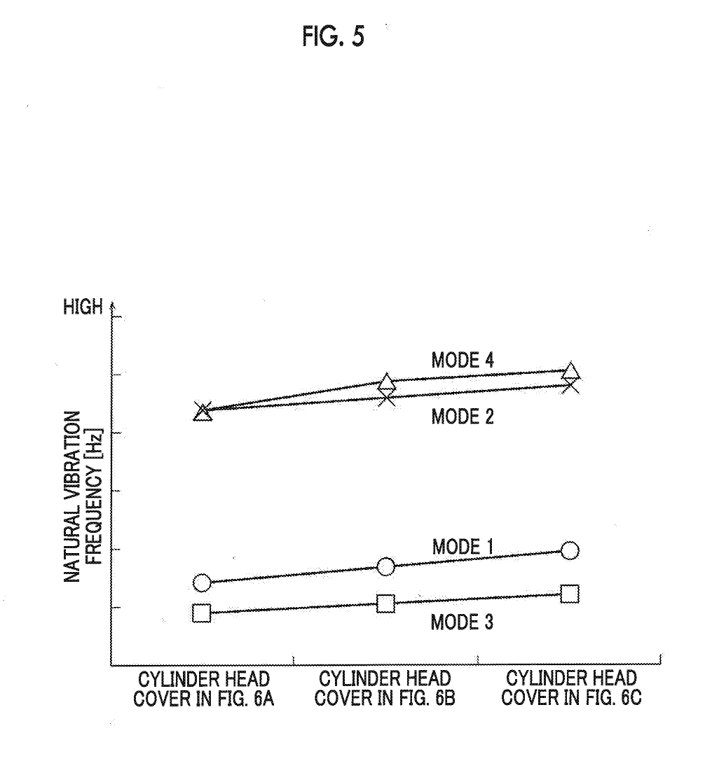

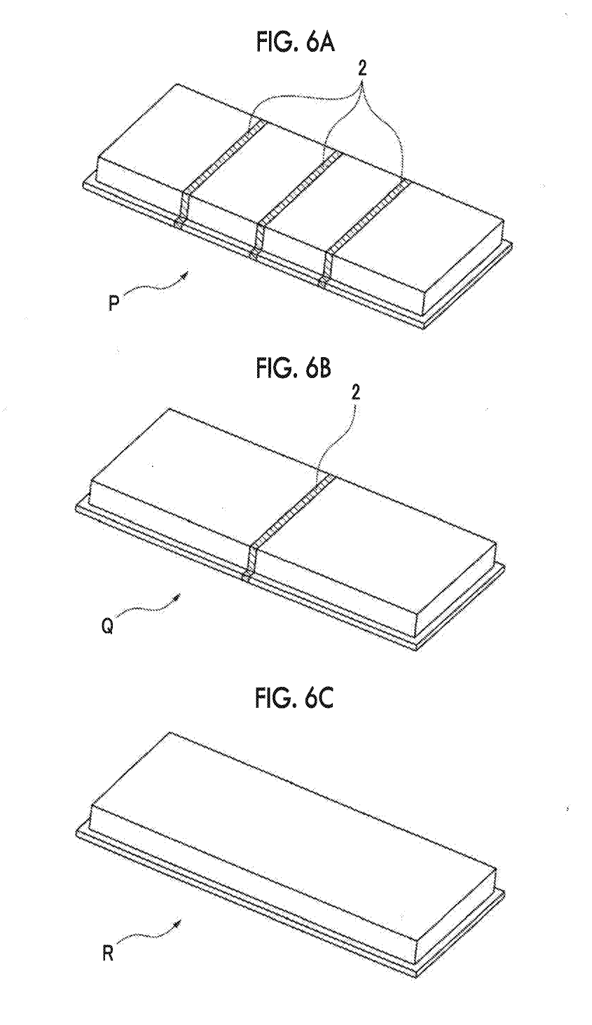

FIG. 5 is a graph showing eigenvalue analysis results regarding the cylinder head covers 1 shown in FIG. 6A to FIG. 6C. In FIG. 5, the natural vibration frequencies of the cylinder head covers 1 are compared in each of vibration modes from mode 1 to mode 4.

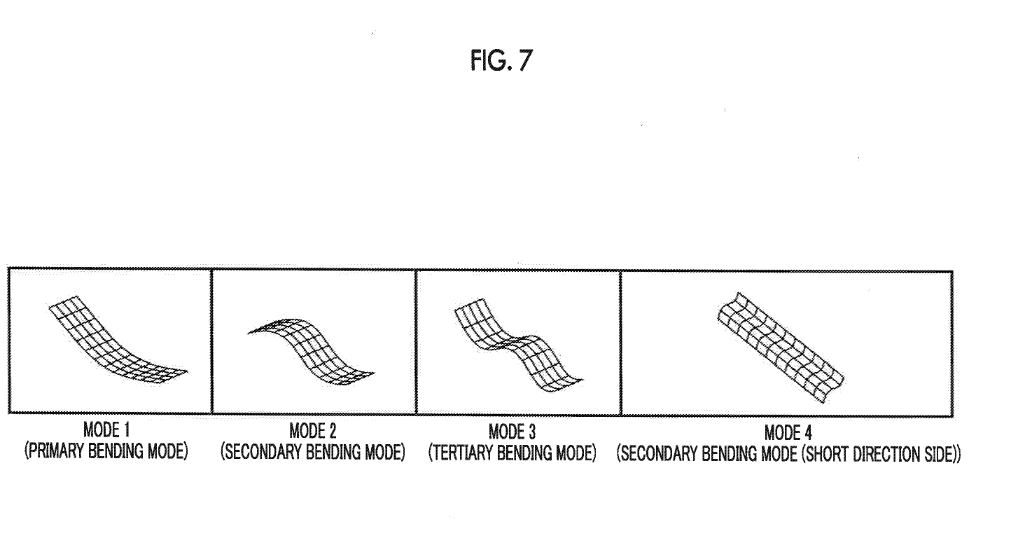

FIG. 6A is a perspective view of a cylinder head cover P in a simplified manner. In the cylinder head cover P, the three density changed portions 2 are provided at equally-spaced intervals in a head cover entire length direction (that is, the head cover longitudinal direction). FIG. 6B is a perspective view of a cylinder head cover Q in a simplified manner. In the cylinder head cover Q, the one density changed portion 2 is provided at a center in the head cover entire length direction (that is, the head cover longitudinal direction). FIG. 6C is a perspective view of a cylinder head cover R in a simplified manner. In the cylinder head cover R, the density changed portion 2 is not provided. Vibration patterns in each of the vibration modes from the mode 1 to the mode 4 are as shown in FIG. 7.

FIG. 5 shows that, in each of the vibration modes, the cylinder head cover R shown in FIG. 6C has the highest natural vibration frequency and the natural vibration frequency is decreased in the order of the cylinder head covers Q, P shown in FIG. 6B and FIG. 6A. That is, it is understood that, as the number of the density changed portions 2 is increased and thus as a ratio of the portions, which have the higher density than that of the main body portion 3, to the main body portion 3 is increased, the natural vibration frequency is shifted to a lower frequency side (in other words, the natural vibration frequency is decreased).

Accordingly, in the case where the density of the density changed portions 2 is set to be higher than the density of the main body portion 3 and the number of the density changed portions 2 remains the same, the natural vibration frequency of the cylinder head cover 1 can be shifted to the lower frequency side (i.e., can be decreased) as the width of each density changed portion 2 is increased. In addition, the natural vibration frequency of the cylinder head cover 1 can be shifted to the lower frequency side (i.e., can be decreased) when the shape of each density changed portion 2 is changed from the linear shape to a shape including a portion with an increased width.

Furthermore, even in the case where the number of the density changed portions 2 remains the same, the natural vibration frequency of the cylinder head cover 1 can be shifted to the lower frequency side (i.e., can be decreased) as the density of each density changed portion 2 is higher than the density of the main body portion 3 by a larger amount (i.e., as an amount, by which the density of each density changed portion 2 is higher than the density of the main body portion 3, is increased). Moreover, the natural vibration frequency of the cylinder head cover 1 can be shifted to the lower frequency side (i.e., can be decreased) when the density of some of the density changed portions 2 is further increased to be higher than the density of the rest of the density changed portions 2.

Thus, by changing the number, the width, the shape, or the density of the density changed portions 2, the natural vibration frequency of the cylinder head cover 1 can be easily changed for adjustment such that the natural vibration frequency of the cylinder head cover 1 does not match the engine vibration frequency.

The cylinder head cover 1 for the internal combustion engine according to the embodiment, which has been described so far, includes the density changed portions 2 provided to extend in the thickness direction of the cylinder head cover 1. The density changed portions 2 divide the cylinder head cover 1 into the plurality of parts, and have the density different from the density of the main body portion 3 of the cylinder head cover 1 (that is, the other portion of the cylinder head cover 1, i.e., the portion of the cylinder head cover 1 other than the density changed portions 2, i.e., the rest of the cylinder head cover 1). In the embodiment, each of the density changed portions 2 has the specified width and is formed to extend over the entire length of the cylinder head cover 1 in the longitudinal direction of the cylinder head cover 1. In addition, each of the density changed portions 2 has the specified width and is formed to extend over the entire length of the cylinder head cover 1 in the short direction of the cylinder head cover 1.

Thus, the cylinder head cover 1 is divided into the plurality of parts by the density changed portions 2, and the main body portion 3 in which the surface vibrations occur is finely divided into parts. Therefore, the area of each of the parts of the main body portion 3, in which the surface vibrations occurs, can be made small. Thus, the magnitude of the vibrations generated in each of the parts, into which the main body portion 3 is divided, can be made small. Therefore, the noise itself generated by the cylinder head cover 1 and the internal combustion engine is suppressed, and thus, the vehicle exterior noise can be suppressed.

By changing the number, the width, the shape, or the density of the density changed portions 2, the natural vibration frequency of the cylinder head cover 1 can be easily changed for adjustment such that the natural vibration frequency of the cylinder head cover 1 does not match the engine vibration frequency. In this way, the resonance of the cylinder head cover 1 can be suppressed. Therefore, the noise itself generated by the cylinder head cover 1 and the internal combustion engine is suppressed, and thus, the vehicle exterior noise can be suppressed.

There is no need to provide the rib on the reverse surface of the cylinder head cover 1 for reinforcement or to increase the thickness of the cylinder head cover 1 for the purpose of preventing the natural vibration frequency of the cylinder head cover 1 from matching the engine vibration frequency. Therefore, it is possible to suppress the increase in the weight of the internal combustion engine and the increase in the weight of the vehicle.

In addition, there is no need to provide an engine cover separately from the internal combustion engine for the purpose of suppressing the vehicle exterior noise. Therefore, it is possible to suppress the increase in the weight of the vehicle resulting from an increase in the number of parts, and to conserve space inside an engine compartment.

In the cylinder head cover 1 according to the embodiment, the material fill density of the density changed portions 2 is different from the material fill density of the main body portion 3 (in other words, the other portion of the cylinder head cover 1, i.e., the portion of the cylinder head cover 1 other than the density changed portions 2, i.e., the rest of the cylinder head cover 1). Thus, the density of the density changed portions 2 is different from the density of the main body portion 3 in the cylinder head cover 1.

Accordingly, the same material can be used for the main body portion 3 and the density changed portions 2 that constitute the cylinder head cover 1, and thus, the cylinder head cover 1 can be integrally formed. Therefore, for example, as compared to a case where the main body portion 3 and the density changed portion 2 are formed as separated parts made of different materials and are joined, rigidity of the cylinder head cover 1 can be increased, and an increase in manufacturing cost of the cylinder head cover 1 can be suppressed.

The embodiment of the disclosure has been described so far. The above embodiment merely illustrates an example in which the disclosure is applied, and thus the technical scope of the disclosure is not limited to the specific configuration in the above embodiment.

For example, in the above embodiment, the plurality of first density changed portions 2a and the plurality of second density changed portions 2b are provided in the cylinder head cover 1. However, at least one of the first density changed portion 2a and the second density changed portion 2b may be provided.

In the above embodiment, the density changed portion 2 has the linear shape. However, the shape of the density changed portion 2 is not limited as long as the density changed portion 2 can divide the cylinder head cover 1 into the plurality of parts. For example, the density changed portion 2 may have a V shape.

In the above embodiment, the density of each density changed portion 2 is set to be higher than the density of the main body portion 3. In contrast, the density of each density changed portion 2 may be set to be lower than the density of the main body portion 3. Thus, by increasing a ratio of portions, which have the lower density than that of the main body portion 3, to the main body portion 3, the natural vibration frequency of the cylinder head cover 1 can be shifted to a higher frequency side (i.e., can be increased).

What is claimed is:

1. A cylinder head cover for an internal combustion engine, the cylinder head cover comprising
a density changed portion provided to extend in a thickness direction of the cylinder head cover, the density changed portion dividing the cylinder head cover into a plurality of parts, and the density changed portion having a density different from a density of a portion of the cylinder head cover other than the density changed portion.

2. The cylinder head cover according to claim 1, wherein the density changed portion includes a first density changed portion that has a specified width and is provided to extend over an entire length of the cylinder head cover in a longitudinal direction of the cylinder head cover.

3. The cylinder head cover according to claim 1, wherein the density changed portion includes a second density changed portion that has a specified width and is provided to extend over an entire length of the cylinder head cover in a short direction of the cylinder head cover.

4. The cylinder head cover according to claim 1, wherein a material fill density of the density changed portion is different from a material fill density of the portion of the cylinder head cover other than the density changed portion.

5. The cylinder head cover according to claim 1, wherein a material of the density changed portion is same as a material of the portion of the cylinder head cover other than the density changed portion.
